(19) United States
(12) Patent Application Publication
(10) Pub. No.: US 2006/0085541 A1
(43) Pub. Date: Apr. 20, 2006

(54) Facilitating optimization of response time in computer networks

(75) Inventors: Gennaro A. Cuomo, Cary, NC (US); Thomas R. Gissel, Apex, NC (US); Harvey W. Gunther, Cary, NC (US); Barton C. Vashaw, Apex, NC (US)

Correspondence Address: A. B. Clay;IBM Corporation, T81/503, 3039 Cornwallis Road, Research Triangle Park, NC, 27709, US

(73) Assignee: International Business Machines Corporation, Armonk, NY (US)

(21) Appl. No.: 10/968,015

(22) Filed: Oct. 19, 2004

(51) Int. Cl. G06F 15/173

(52) U.S. Cl. 709/224

(57) ABSTRACT

A system and method are disclosed for leveraging bandwidth and processor utilization to advantageously influence response time performance. The objective of such leveraging is to maximize transaction throughput (e.g., requests per second) between a pair of servers when the servers are connected through less than optimal networks and/or network connections. Such an optimization is accomplished by determining whether or not adjusting request and/or reply sizes by applying a compression factor (i.e., to facilitate compression) will have a desirable influence on response time performance. Such determination is based on decision criteria including, but are not limited to, network protocol performance, CPU utilization, bandwidth utilization, and estimates of the CPU time and network time costs of sending compressed verses uncompressed data.

### FIELD OF THE DISCLOSURE

The disclosures made herein relate generally to computer networks and computer-implemented methodologies configured for improve response time and, more particularly, to facilitating data compression to improve response time.

### BACKGROUND

In the context of data transmission between networked data processing systems, response time is the duration of time between a first data processing system (e.g., a first server) providing a request for information to a second data processing system (e.g., a second server) and data constituting the requested information being received in its entirety by the first data processing system from the second data processing system. The response time corresponds to the latency, or ‘wait-time’, of the first data processing system with respect to requesting information and waiting for receipt of a corresponding reply. Accordingly, it can be seen that optimizing response time (e.g., reducing response time and/or maintaining response time at an acceptable or specified level) is desirable as it directly influences the overall quality-of-service experienced by clients of a data processing system.

Round-trip time (RTT) is a common metric used for quantifying response time. Conventional means for measuring RTT on a connection between two data processing systems include suitably configured network utilities (e.g., PING utility, TRACEROUTE utility, etc), various configurations of echo utilities, and/or passively monitoring the response time of active connections. In one specific example, RTT is determined by measuring the time it takes a given network packet (i.e., reference data) to travel from a source data processing system to a destination data processing system and back. Examples of factors that affect RTT include, but are not limited to, time for compressing data, time required for sending (i.e., transferring) data to a protocol stack, request sending time, network delay, network congestion, network loss percentage, and decompression time. Because RTT is affected by network congestion, RTT varies over time and is typically calculated on a per-partner basis.

Approaches for reducing response time in computer networks are known (i.e., conventional approaches for reducing response time). The underlying goal of such conventional approaches is to modify data being transmitted by a data processing system (e.g., via data compression, data omission, etc.) and/or modifying operating parameters of the data processing system in a manner that results in a reduction in response time for all or a portion of data being transmitted by the data processing system. However, such conventional approaches for reducing response time are known to have drawbacks that adversely affect their effectiveness, desirability and/or practicality.

One example of such conventional approaches for reducing response time includes requiring that an administrator or an application (i.e., a controlling entity) decide whether the use of data compression is or is not desirable for reducing response time. But, because administrator and/or applications upon which these conventional approaches rely are limited in their ability to readily provide complete and accurate decision-making information, it is often the case that these conventional approaches routinely result in non-optimal decisions being made regarding compression. Example of such non-optimal decisions include, but are not limited to, implementing too much compression, implementing too little compression, and implementing a less than preferred compression technique. In some instances, these non-optimal decisions include simply ignoring the issue of compression all together and tolerating less than optimal response times.

Another example of such conventional approaches for reducing response time includes analyzing subject data and determining which portions of the subject data can be omitted from being transmitted, whether in a compressed or uncompressed format. To this end, it is typically necessary to have a fairly detailed understanding of the subject data such that only non-essential information comprised by the subject data (e.g., certain background information in images) is omitted. A drawback of this type of conventional approach is that it is generally not a practical solution in instances where the content and configuration of data cannot be readily and rapidly determined and/or is not predefined. Another drawback is that analyzing the subject data can be time-consuming and processor intensive.

Yet another example of such conventional approaches for reducing response time includes deploying and activating client and server components of a data compression algorithm (i.e., network middleware) on networked computer systems. In such conventional approaches, the client and server components comprise respective portions of the data compression algorithm that jointly facilitate determination of whether to compress subject data and, in instances where compression is deemed appropriate, facilitate respective portions of compression/decompression functionality. Due to the client-server processing requirements of such a conventional approach, response time optimization functionality afforded by the data compression cannot be carried out in conjunction with a computer system not configured with one or both components of the data compression algorithm (i.e., the client component and/or the server component). This is a drawback in that it limits usefulness, effectiveness and practicality. Another drawback of this type of conventional approach is that extra burden is placed on the CPU and storage means of the client system for maintaining information required for facilitating functionality of the data processing algorithm. Still another drawback is that deployment of client and server components of this type of data compression algorithm is mandated.

Therefore, a system and/or method that overcomes drawbacks associated with conventional approaches for reducing response time would be useful, advantageous and novel.

### SUMMARY OF THE DISCLOSURE

The inventive disclosures made herein relate to facilitating adaptive implementations of data compression for optimizing response time performance in a data processing system. Such implementations rely on a determination of whether or not adjusting request and/or reply sizes at the data processing system by applying a compression factor (i.e., to facilitate compression) have a desirable influence on response time performance. Such determination is based on a wide variety of decision criteria. Examples of the decision criteria include, but are not limited to, network protocol performance, CPU utilization, bandwidth utilization, and estimates of the CPU time and network time costs of sending compressed verses uncompressed data.

Through experimentation, it has been found that improvement in response time and throughput more than offsets costs associated with facilitating compression. Conversely, it has also been found that facilitating compression can degrade performance in instances where its facilitation results in the use of additional CPU time. Accordingly, systems and methods in accordance with embodiments of the inventive disclosures made herein have an underlying intent of determining how bandwidth and processor utilization can be leveraged to advantageously influence (e.g., optimize) response time performance. The objective of such leveraging is to optimize (e.g., maximize) transaction throughput (e.g., requests per second) between a pair of servers when the servers are connected through less than optimal networks and/or network connections. An edge server and an application server are an example of such pair of servers.

In a first embodiment of a method for facilitating optimization of resource utilization in accordance with the inventive disclosures made herein, operating parameter levels exhibited by a data processing system are determined. At least a portion of the operating parameter levels influence response time performance for the data processing system. After the operating parameter levels are determined, a resource optimization mode is determined dependent upon one or more of the operating parameter levels. Thereafter, a data compression influence on the response time performance is determined dependent upon the determined resource optimization mode.

In a second embodiment of a method for facilitating optimization of resource utilization in accordance with the inventive disclosures made herein, a resource optimization mode for a data processing system is determined dependent upon one or more of a plurality of operating parameter levels exhibited by the data processing system. A resource optimization strategy is then implemented dependent upon resource optimization modes, the operating parameter levels, and/or reference responsiveness parameters. Information utilized in determining the resource optimization strategy is modified dependent upon information derived from implementation of the resource optimization strategy, thereby enabling resource optimization functionality to be adaptively implemented based on historic and current information.

In a third embodiment of a method for facilitating optimization of resource utilization in accordance with the inventive disclosures made herein, operating parameter levels exhibited by a data processing system are determined and at least a portion of the operating parameter levels influence response time performance exhibited by the data processing system. Uncompressed data transmission or a first data compression method is implemented in response to processor utilization exhibited by the data processing system exceeding a respective specified threshold. A second data compression method is implemented in response to bandwidth utilization exhibited by the data processing system exceeding a respective specified threshold. Round-trip time optimization is implemented in response to the processor utilization and the bandwidth utilization being below the respective specified thresholds.

### BRIEF DESCRIPTION OF THE DRAWING FIGS.

FIG. 1 depicts an embodiment of a method for facilitating resource optimization functionality in accordance with the inventive disclosures made herein.

FIG. 2 depicts an embodiment of an operation for determining a resource optimization mode in accordance wit the method depicted in FIG. 1.

FIG. 3 depicts an embodiment of an operation for implementing a resource optimization strategy in accordance with the method depicted in FIG. 1.

FIG. 4 depicts an embodiment of an operation for optimizing data compression influence in accordance with the method depicted in FIG. 1.

FIG. 5 depicts an embodiment of a network system configured for carrying out resource optimization functionality in accordance with the inventive disclosures made herein.

### DETAILED DESCRIPTION OF THE DRAWING FIGURES

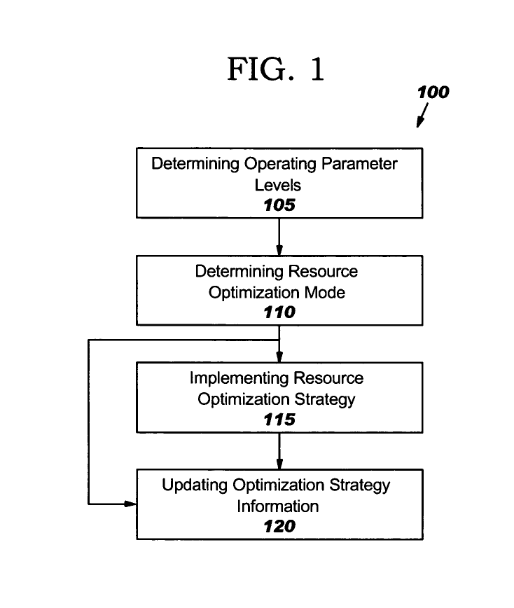

FIG. 1 depicts an embodiment of a method (referred to generally as method 100) in accordance with the inventive disclosures made herein. Method 100 is configured for facilitating resource optimization of a data processing system in accordance with the inventive disclosures made herein. The overall goal of such resource optimization is to leverage processor utilization and bandwidth utilization levels for advantageously influencing response time performance (e.g., optimizing response time) for the data processing system.

Method 100 begins with operation 105 for determining operating parameter levels for a data processing system (e.g., a server). In one example, determining operating parameter levels includes monitoring, measuring, estimating and/or storing all or a portion of such operating parameter levels. In the context of the inventive disclosures presented herein, the term “operating parameter levels” includes operating parameter levels related to one or more associated network connections of the data processing system in addition to operating parameter levels of resources of the data processing system. Accordingly, examples of such operating parameters include, but are not limited to, monitoring processor utilization, monitoring aggregate bandwidth utilization, measuring network parameters (e.g., round trip time, latency, etc) and estimating compressibility of outbound data.

After determining the operating parameter levels, operation 110 is performed for determining a resource optimization mode. Embodiments of resource optimization modes in accordance with the inventive disclosures made herein include a mode in which processor cycles are optimized (i.e., processor optimization mode), a mode in which aggregate bandwidth is optimized (i.e., a bandwidth optimization mode), and a mode in which round trip time is optimized (i.e., a round-trip time optimization mode). Determination of the resource optimization mode is performed dependent upon one or more of the operating parameter levels exhibited by the data processing system. In one embodiment, determining the resource optimization mode preferably includes selecting the processor optimization mode in response to determining that response time performance is bound by processor utilization (i.e., processor cycles), selecting bandwidth optimization mode in response to determining that the response time performance is bound by bandwidth utilization (e.g., aggregate bandwidth utilization), and selecting round-trip time optimization mode in response to determining that the response time performance is unbound by processor utilization and bandwidth utilization.

It will be understood by a skilled person that the term ‘optimization’ as used herein is a non-absolute term. For example, optimized response time performance for a data processing system may not correspond to absolute optimization of response time performance assuming infinite availability of information, knowledge and time, but rather the best response time performance achievable based on availability and/or practical allocation of information, knowledge and time. In effect, the preferred intent is to pursue absolute optimization to the degree possible in view of factors such as available and/or practical allocation of information, knowledge and time.

Operation 115 is performed for implementing a resource optimization strategy after determining the resource optimization mode. Implementation of the resource optimization strategy is performed dependent upon the determined resource optimization mode, the operating parameter levels, and/or reference responsiveness parameters. Examples of such responsiveness parameters include, but are not limited to, reference round-trip times, reference latencies and reference response times.

In conjunction with performing implementation of the compression strategy, operation 120 is performed for updating optimization strategy information. Such updating of optimization strategy information includes, but is not limited to, adding new information, deleting existing information, replacing existing information and/or modifying existing information. In one embodiment, updating of optimization strategy information is preferably performed dependent upon information derived from implementing the resource optimization strategy. Examples of optimization strategy information include, but are not limited to, information related to processor utilization, information related to aggregate bandwidth utilization, information related to network parameters (e.g., round trip time, latency, etc), and information related to compressibility of reference outbound data.

By updating optimization strategy information in an integrated manner with implementing resource optimization strategies, resource optimization functionality in accordance with the inventive disclosures made herein may be implemented in an adaptive manner. For example, on-going implementation of resource optimization functionality results in new, deleted, replaced and/or modified optimization strategy information. Accordingly, on-going implementation of the resource implementation functionality serves to enhance the breadth, context, content and resolution of the optimization strategy information in an automated manner and, thereby, enables resource optimization functionality to be implemented in an adaptive (e.g., self-regulating) manner.

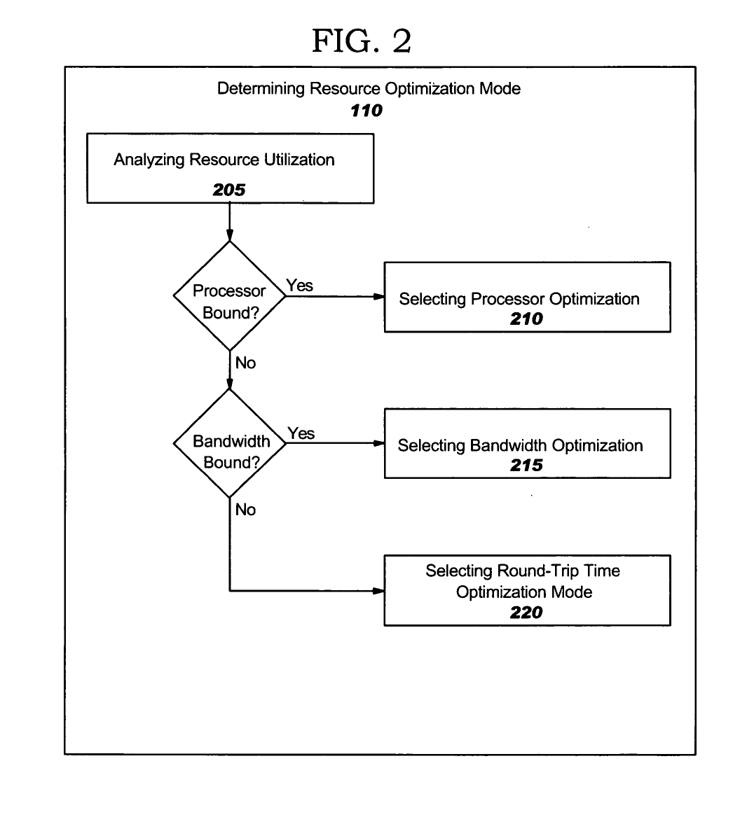

FIG. 2 depicts an embodiment of the operation 110 (depicted in FIG. 1) for determining the resource optimization mode. Operation 205 is performed for analyzing resource utilization. Examples of information analyzed includes, but is not limited to, information related to processor utilization, information related to aggregate bandwidth utilization, information related to network parameters (e.g., round trip time, latency, etc), and information related to compressibility of reference outbound data.

In response to analysis of the resource utilization determining that response time performance is bound by processor utilization, operation 210 is performed for selecting a processor optimization mode. In response to analysis of the resource utilization determining that response time performance is bound by bandwidth utilization rather than processor utilization, operation 215 is performed for selecting a processor optimization mode. In response to analysis of the resource utilization determining that response time performance is unbound by bandwidth utilization and processor utilization, operation 220 is performed for selecting round-trip time optimization mode. Presented below is an example of modeling approach use for determining resource optimization mode applicability.

### EXAMPLE

### Network Experimentation For Determining Resource Optimization Mode Applicability

The goal of this experiment was to determine how bandwidth and processor utilization influenced whether or not outbound data should be compressed in an effort to optimize response time performance. The results predict which type of resource optimization mode (e.g., which type of resource utilization leveraging) best applies to different types of network operating scenarios.

A 5-system network with one network switch was used to facilitate this experiment. A first pair of systems was configured as partner-system on the network and was used to conduct the test. A second pair of systems was configured to interject network overhead on the switch. The fifth system was configured as a proxy server that could be tuned to be a network bottleneck. Five cases depict the overall results of the experiment.

CASE 1: Two Systems, both CPU constrained by using background activity. Perfect network; Light network usage. Chosen compression approach did not yield an advantageous affect on response time performance.

CASE 2: Two Systems, light system usage but network constrained using a “Proxy Server” on an intermediate box. Compression could be implemented in a manner that yielded an advantageous affect on response time performance.

CASE 3: Two Systems, light system usage, plenty of network capacity but nerwork noise interjected by the other two systems. Chosen compression approach did not yield an advantageous affect on response time performance.

CASE 4: Two systems, heavy CPU usage, network bottleneck using a “Proxy Server”. Chosen compression approach did not yield an advantageous affect on response time performance.

CASE 5: Two systems, heavy CPU usage, busy network (effectively, the same as CASE 4.) Chosen compression approach did not yield an advantageous affect on response time performance.

In summary, the detailed information gathered in this experiment found that:

(1) If a server is CPU-bound, optimizing processor utilization (i.e., processor cycles) is typically advantageous. Accordingly, a comparison would dictate the preference of sending outbound data in an uncompressed form or sending outbound data after being compressed using a looser and/or a less expensive compression method (e.g., a lossy-type compression method).

(2) If a server is bandwidth bound, optimizing network bandwidth is typically advantageous. Accordingly, data compression would be used to its maximum benefit in view of bandwidth utilization.

(3) If a server is unbound by processor and bandwidth utilization, optimizing round-trip time is typically advantageous. Accordingly, because incurring extra processor overhead for very little return benefit becomes counter-productive, a comparison would dictate the preference of sending outbound data in uncompressed form or sending outbound data after being compressed using one of any number of compression methods.

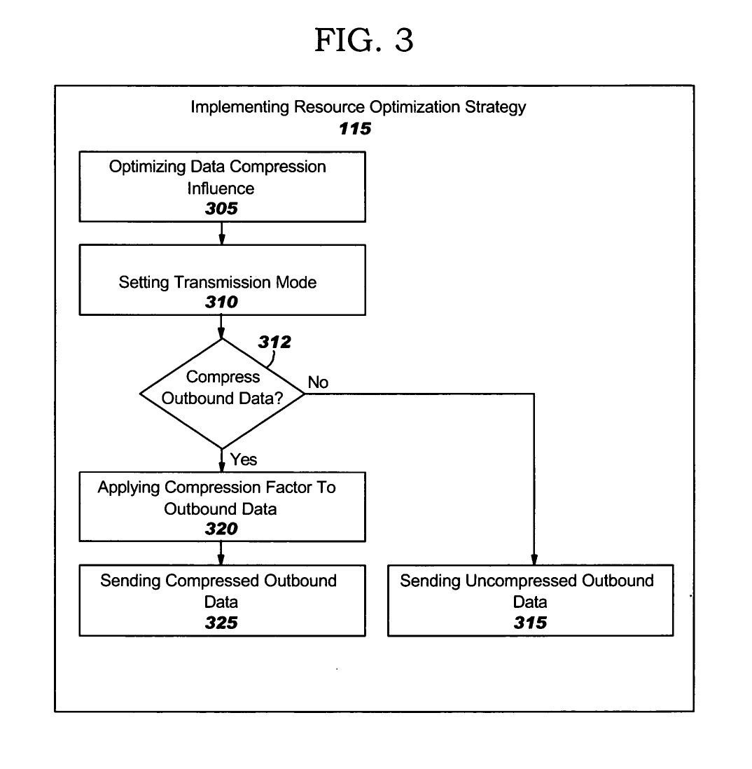

FIG. 3 depicts an embodiment of the operation 115 (depicted in FIG. 1) for implementing resource optimization strategy. Operation 305 is performed for optimizing a data compression influence on outbound data. Optimization of the data compression influence is performed dependent upon information that is at least partially specific to the selected resource optimization mode. Examples of such information includes, but are not limited to, information relating to a preferred data compression method, information relating to a calculated compression factor, information relating to processor utilization, information related to aggregate bandwidth utilization, information related to network parameters (e.g., round trip time, latency, etc), and information related to compressibility of reference outbound data.

After optimizing the data compression influence, operation 310 is performed for setting a transmission mode that is dependent upon optimization of data compression. A first transmission mode includes sending outbound data in a compressed form in response to compressing outbound data in accordance with a preferred compression factor determined during optimization of the data compression influence on outbound data (i.e., during operation 305). Examples of such a determined compression factor include, but are not limited to, a compression factor calculated dependent upon a suitable formula, a compression factor selected from a collection of pre-defined compression factors, and a compression factor selected from a collection of previously utilized compression factors. A second transmission mode includes sending outbound data in an uncompressed form.

In response to setting the transmission mode for sending outbound data in an uncompressed form, operation 315 is performed for sending outbound data in an uncompressed form. In response to setting the transmission mode for sending outbound data in a compressed form, operation 320 for applying the preferred compression factor to outbound data and operation 325 is performed for sending the outbound data in a corresponding compressed form. Accordingly, implementing the resource optimization strategy results in data being sent in the form that provides optimized response time performance.

Generally speaking, the operation of determining what resource(s) should be optimized is implemented in any manner that accomplished the overall objective of optimizing aggregate response time performance for a server (e.g., what particular resource a server administrator should optimize). As discussed above, an example of an approach for determining the manner in which data compression should be applied includes utilizing experimentation for determining criteria and parameters upon which to base a compression factor to apply. Also discussed above is the effect of optimization strategy information being maintained in a manner that enables resource optimization functionality to be implemented adaptively. Accordingly, the compression factor and its specific means of generation will typically vary on a case-by-case basis.

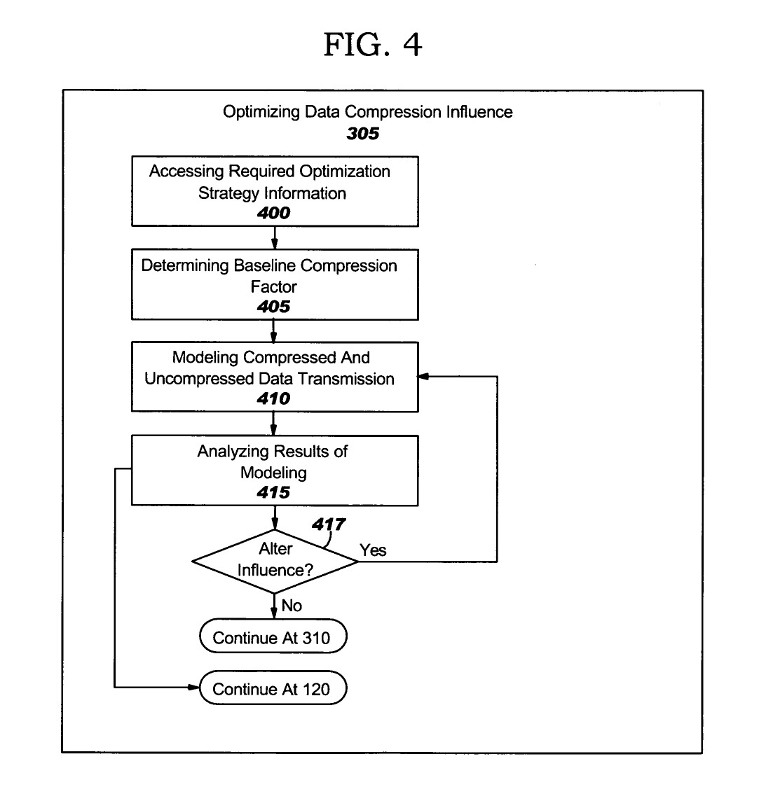

FIG. 4 depicts an embodiment of the operation 305 (depicted in FIG. 1) for optimizing data compression influence. Operation 400 is performed for accessing required optimization strategy information. In response to accessing the required optimization strategy information, operation 405 is performed for determining a corresponding compression factor dependent upon the required optimization strategy information. In one embodiment, the required optimization strategy information is maintained in an information structure (e.g., a data base or object environment) and includes historic and/or specified operating parameter levels that are correlated to known desirable response time influences and to a corresponding compression factor. Through a simple look-up operation a baseline compression factor can be determined. In another embodiment, the required optimization strategy information includes a collection of formulas that are each known to produce a desirable compression factor (e.g., compression factors that provide desirable response time influences) for a particular resource optimization mode. Through a simple look-up of the formula that corresponds to a particular resource optimization mode, a baseline compression factor can be calculated. In another embodiment, the required resource optimization information directly correlates a given resource optimization mode to a baseline compression factor.

After determining the baseline compression factor, operation 410 is performed for modeling uncompressed data transmission and compressed data transmission using the baseline compression factor. Operation 415 is performed for analyzing results of the modeling in response to performing the modeling. In one embodiment, the modeling includes sending reference outbound data in an uncompressed form and in a compressed form as generated using the baseline compression factor, and the analysis includes comparing response time performance in view of one or more operating parameter levels for the uncompressed and compressed data.

In one embodiment, the comparison is preferably based on resource utilization parameters. For example, in response to determining that response time performance is bound by processor utilization, processor cycles required for compressing outbound data and sending the compressed outbound data are compared with processor cycles required for sending the outbound data in uncompressed form. In response to determining that the response time performance is bound by bandwidth utilization, bandwidth utilization associated with sending the outbound data in compressed form is compared with bandwidth utilization associated with sending the outbound data in uncompressed form. In response to determining that the response time performance is unbound by processor utilization and bandwidth utilization, round-trip time for the outbound data in compressed form is compared with round-trip time for the outbound data in uncompressed form.

If the data compression influence associated with the compression factor and the utilized compression method is not acceptable (e.g., above or below a respective threshold value), the analysis of operation 415 may optionally determine a revised compression factor, if so practical and/or useful. An example of the compression factor and utilized compression method yielding unacceptable influence is when resource utilization and/or response time performance dictate sending outbound data in the uncompressed form is preferred over the corresponding compressed form. In one embodiment, the revised compression factor is derived as a scaling of the previously determined compression factor. In another embodiment, the revised compression factor is calculated using the same or different approach as used in operation 405 with revised assumptions and/or variable information (e.g., adaptively based on updated resource optimization information).

In response to a revised compression factor being determined, operations 410 and 415 are repeated. In response to a revised compression factor not being determined, the method continues at operation 310. In one embodiment, the method continuing at the operation 310 serves as a trigger for performing operation 120 (FIG. 1), in which case historical optimizing strategy information is modified dependent upon information accesses and/or derived in association with performing operations 410 and/or 415. It is contemplated and disclosed herein that, in alternate embodiments of methods in accordance with the inventive disclosures made herein, the functionality for determining revised compression factors at operation 415 may be omitted, in which case, the baseline compression factor is the compression factor applied to outbound data at operation 320 (FIG. 3).

Referring now to computer readable medium, it will be understood by the skilled person that methods, processes and/or operations adapted for carrying out resource optimization functionality in accordance with the inventive disclosures made herein are tangibly embodied by computer readable medium having instructions thereon for carrying out such functionality. In one specific embodiment, the instructions are tangibly embodied for carrying out the method 100 disclosed above to facilitate resource optimization functionality (e.g., as a resource optimization utility running on a data processing system). The instructions may be accessible by one or more data processors (e.g., a logic circuit of a data processing system providing server functionality) from a memory apparatus (e.g. RAM, ROM, virtual memory, hard drive memory, etc), from an apparatus readable by a drive unit of the data processing system (e.g., a diskette, a compact disk, a tape cartridge, etc) or both. Accordingly, embodiments of computer readable medium in accordance with the inventive disclosures made herein include a compact disk, a hard drive, RAM or other type of storage apparatus that has imaged thereon a computer program (i.e., a set of instructions) adapted for carrying out resource optimization functionality in accordance with the inventive disclosures made herein.

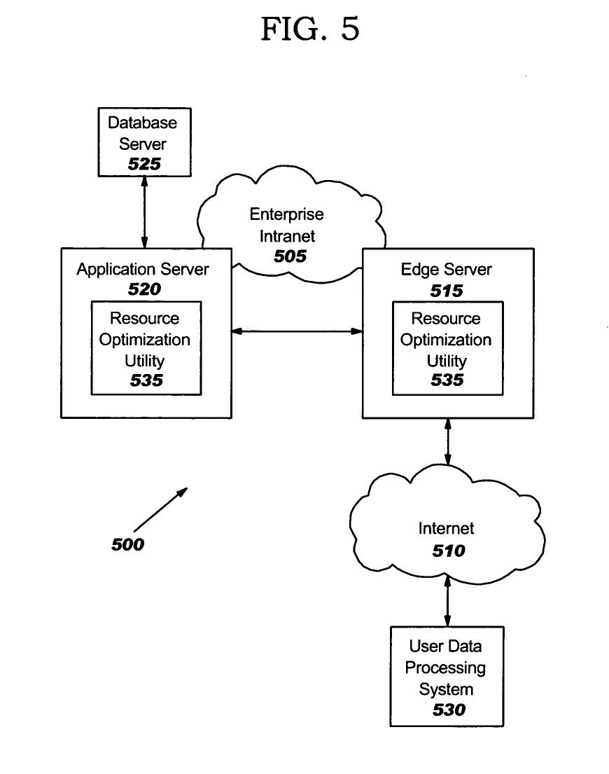

FIG. 5 depicts an embodiment of a network system (generally referred to as network system 500) that is configured for carrying out resource optimization functionality in accordance with the inventive disclosures made herein. Network apparatus 500 includes enterprise intranet 505 (i.e., a first network) and Internet 510 (i.e., a second network). Enterprise intranet 505 includes edge server 515 (i.e., a first server), application server 520 (i.e., a second server) and database server 525 (i.e., a third server). User data processing system 530 is configured for accessing information from enterprise intranet 505 via access through Internet 510. As will be discussed in greater detail below, the information is served toward Internet 510 by application server 520 through edge server 515. A personal computer configured with a network interface device is an example of user data processing system 530. In practice, embodiments of the network apparatus 500 will include a plurality of user data processing systems configured for accessing information via Internet 510 and enterprise intranet 505 will typically include a plurality of networked application and edge servers.

Edge server 515 includes inbound optimization layer 535 and application server 520 includes outbound optimization layer 540. Inbound optimization layer 535 is preferably, but not necessarily, implemented at an inbound point from edge server 515 to application server 520 for supporting request flow. Outbound optimization layer 540 is preferably, but not necessarily, implemented at an outbound point from application server 520 to Edge Server 515 for supporting return or response flow.

Inbound optimization layer 535 and outbound optimization layer 540 are each configured for enabling resource optimization functionality to be carried out in accordance with the inventive disclosures made herein. In one specific embodiment, inbound optimization layer 535 and outbound optimization layer 540 each preferably includes instructions for carrying out all or a portion of method 100 depicted in FIG. 1. Inbound optimization layer 535 and outbound optimization layer 540 are each standalone implementations rather than a client-server type of middleware that resides on pairs of servers. Accordingly, resource optimization functionality in accordance with the inventive disclosures made herein may be advantageously and fully implemented by each optimization layer (535, 540).

Inbound optimization layer 535 tracks CPU utilization of edge server 515 and outbound optimization layer 540 tracks CPU utilization of application server 520. If edge server 515 or application server 520 is operating at or above a prescribed processing level (e.g., 90%), the respective optimization layer (i.e., inbound optimization layer 535 or outbound optimization layer 540, respectively) does not implement compression and communicates such decision to the other server through, for example, a custom HTTP header. Inbound optimization layer 535 and outbound optimization layer 540 continually monitor respective CPU utilization and the respective compression decision is revisited iteratively.

At initialization, edge server 515 reads a set of parameters that define system goals associated with implementing resource optimization (e.g., server throughput optimization) in accordance with the inventive disclosures made herein. Additionally, at initialization, edge server 515 performs a TRACEROUTE (or equivalent) operation for determining the number of hops and delays. In initiating a request to the application server 520, edge server 515 examines CPU utilization and makes a determination of whether or not to compress the inbound message to application server 520. If edge server 515 is operating below a predefined level (e.g., at less than 90% busy) and request/responses are operating within a predefined level (e.g., 90% of the system goals for response time based on tracked history over the last 30 seconds, the last five minutes, and last 30 minutes), edge server 515 will compress the message.

Edge server 515, in sending the message, monitors request/response times and maintains a profile of response times over a predefined or system-defined duration (e.g., the last 30 seconds, the last five minutes and last 30 minutes). Preferably, this profile is hardened so as to be persistent across restarts. Application server 520, in processing the message, sends a reply. Based on CPU utilization tracking, if application server 520 determines (e.g., based on the last 30 seconds, the last five minutes and the last 30 minutes) that CPU utilization of both edge server 515 and application server 520 is less than a predefined level (e.g., 90%), and then the reply is compressed.

In one embodiment, edge server 515 preferably uses an architected message format (i.e., custom configured in accordance with the inventive disclosures made herein) for facilitating compression. The architected message format provides for a first compression header that includes the uncompressed length of a message in the compression header and that indicates whether or not compression is being used and the length of the uncompressed header. A second HTTP header includes the CPU utilization of edge server 515 over a predefined or system-defined duration (e.g., the last 3 seconds, the last five minutes, and last 30 minutes).

A novel and advantageous aspect of resource utilization in accordance with the inventive disclosures made herein for compression optimization is that edge server 515 caches and re-uses inflator/deflator objects. Saving and contributions from such caching and from such re-using of inflator/deflator object towards compression optimization is very significant. Deflator objects provide compression of data using a variety of parameters, which define the type and extent of the compression (e.g., the optimization strategy information disclosed in reference to FIG. 4). Inflator objects handle data compressed using a particular deflator object to un-compress the compressed data. Typically, inflator and deflator objects perform their respective functionalities via a buffer (e.g., cache), but are also extensible to support streamed data.

Application server 520 includes hardware and software that handles all application operations between user data processing systems (e.g., user data processing system 530) and backend applications and/or databases (e.g., a database residing on database server 525). Application servers such as application server 520 are typically used for complex, transaction-based applications. Edge server 515 includes hardware and software that serves the function of distributing application processing of application server 520 to the edge of the enterprise intranet 505, preferably using centralized administrative and application control.

In one embodiment, edge server 515 is a specialized type of application server that performs application front end processing. Caching is an example of such front end processing functionality. Various configurations of edge servers, application servers and data base servers are commercially available from numerous venders. WebSphere® Edge Server and WebSphere® Application Server, both commercially available from IBM Corporation, are a specific examples edge server 515 and application server 520, respectively.

Embodiments of systems and methods in accordance with the inventive disclosures made herein are applicable to a variety of types of network communications and architectures. In one specific embodiment, the target network communications are those between edge servers and application server. Generally speaking, however, embodiments of such systems and methods may be implemented in conjunction with most types of network communication protocols.

In accordance with at least one embodiment of the inventive disclosures made herein, it is required that compressed data be provided in a message that is formatted in a manner indicating that compression is in use and what form of compression is in use. HyperText Transfer Protocol (HTTP) is an example of a communication protocol that provides the use of header information configured for indicating that compression is in use and what form of compression is in use. Accordingly, HTTP is one example of a communication protocol configured in a manner that allows compression information (e.g., presence and type of compressed data) to be provided to sending and receiving parties in a communication and is thus one example of a communication protocol compatible with embodiments of methods and systems in accordance with the inventive disclosures made herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method configured for facilitating optimization of resource utilization in a data processing system, comprising:
determining operating parameter levels exhibited by a data processing system, wherein at least a portion of said operating parameter levels influence response time performance for the data processing system;
determining resource optimization mode dependent upon at least one of said operating parameter levels; and
determining data compression influence on said response time performance dependent upon said resource optimization mode.

2. The method of claim 1 wherein determining said operating parameter levels includes at least one of monitoring processor utilization, monitoring aggregate bandwidth utilization, measuring network parameters and estimating compressibility of outbound data.

3. The method of claim 1 wherein determining said resource optimization mode includes:
selecting processor optimization mode in response to determining that said response time performance for the data processing unit is bound by processor utilization;
selecting bandwidth optimization mode in response to determining that said response time performance for the data processing system is bound by bandwidth utilization; and
selecting round-trip time optimization mode in response to determining that said response time performance for the data processing system is unbound by processor utilization and bandwidth utilization.

4. The method of claim 3 wherein optimizing said data compression influence includes at least one of:
in response to choosing processor optimization mode, comparing processor cycles required for compressing outbound data and sending said compressed outbound data and processor cycles required for sending said outbound data in uncompressed form;
in response to choosing bandwidth optimization mode, comparing bandwidth utilization associated with sending said outbound data in compressed form and bandwidth utilization associated with sending said outbound data in uncompressed form; and
in response to choosing round-trip time optimization mode, comparing round-trip time for outbound data in compressed form and round-trip time for outbound data in uncompressed form.

5. The method of claim 1 wherein optimizing said data compression influence includes at least one of:
in response to determining that response time performance for the data processing unit is bound by processor utilization, comparing processor cycles required for compressing outbound data and sending said compressed outbound data and processor cycles required for sending said outbound data in uncompressed form;
in response to determining that said response time performance for the data processing unit is bound by bandwidth utilization, comparing bandwidth utilization associated with sending said outbound data in compressed form and bandwidth utilization associated with sending said outbound data in uncompressed form; and
in response to determining that said response time performance is unbound by processor utilization and bandwidth utilization, comparing round-trip time for outbound data in compressed form and round-trip time for outbound data in uncompressed form.

6. The method of claim 1, further comprising:
compressing outbound data from the data processing systems in response to optimizing said data compression in a manner provides a desired influence, wherein optimizing said data compression influence includes determining a compression factor and compressing said outbound data includes applying the compression factor to said outbound data.

7. The method of claim 6, further comprising:
updating information used in determining the compression factor in response to optimizing the influence of said data compression.

8. A method configured for facilitating optimization of resource utilization in a data processing system, comprising:
determining resource optimization mode for a data processing system dependent upon at least one of a plurality of operating parameter levels exhibited by the data processing system;
implementing a resource optimization strategy dependent upon at least one of said resource optimization modes, said operating parameter levels, and reference responsiveness parameters; and
updating information utilized in determining the resource optimization strategy dependent upon information derived from said implementing the resource optimization strategy.

9. The method of claim 8 wherein determining said resource optimization mode includes:
selecting processor optimization mode in response to determining that said response time performance for the data processing unit is bound by processor utilization;
selecting bandwidth optimization mode in response to determining that said response time performance for the data processing system is bound by bandwidth utilization; and
selecting round-trip time optimization mode in response to determining that said response time performance for the data processing system is unbound by processor utilization and bandwidth utilization.

10. The method of claim 9 wherein implementing said resource optimization strategy includes determining data compression influence on said response time performance dependent upon said resource optimization mode.

11. The method of claim 10 wherein optimizing said data compression influence includes at least one of:
in response to determining that response time performance for the data processing unit is bound by processor utilization, comparing processor cycles required for compressing outbound data and sending said compressed outbound data and processor cycles required for sending said outbound data in uncompressed form;
in response to determining that said response time performance for the data processing unit is bound by bandwidth utilization, comparing bandwidth utilization associated with sending said outbound data in compressed form and bandwidth utilization associated with sending said outbound data in uncompressed form; and
in response to determining that said response time performance is unbound by processor utilization and bandwidth utilization, comparing round-trip time for outbound data in compressed form and round-trip time for outbound data in uncompressed form.

12. The method of claim 10 wherein implementing said resource optimization strategy includes compressing outbound data from the data processing systems in response to optimizing said data compression in a manner that provides a desired influence, wherein optimizing said data compression influence includes determining a compression factor and compressing said outbound data includes applying the compression factor to said outbound data.

13. The method of claim 12, further comprising:
updating information used in determining the compression factor in response to optimizing the influence of said data compression.

14. The method of claim 8 wherein:
implementing the resource optimization strategy is performed in response to optimizing said data compression in a manner that provides a desired influence; and
said implementing includes:
implementing one of uncompressed data transmission and a first data compression method in response to processor utilization exhibited by the data processing system exceeding a respective specified threshold;
implementing a second data compression method in response to bandwidth utilization exhibited by the data processing system exceeding a respective specified threshold and
implementing a round-trip time optimization strategy in response to said processor utilization and said bandwidth utilization being below said respective specified thresholds.

15. The method of claim 14 wherein:
implementing the first data compression method includes sending outbound data in a compressed form created using a lossy-type data compression method;
implementing the second data compression method includes compressing outbound data in a manner that provides for a corresponding compression-induced increase in response time performance; and
implementing the round-trip optimization strategy includes sending said outbound data in a compressed form in response to determining round-trip time for sending said outbound data in said compressed form is less than round-trip time for said outbound data in uncompressed form.

16. A method configured for facilitating optimization of resource utilization in a data processing system, comprising:
determining operating parameter levels exhibited by a data processing system, wherein said operating parameter levels influence response time performance exhibited by the data processing system;
implementing one of uncompressed data transmission and a first data compression method in response to processor utilization exhibited by the data processing system exceeding a respective specified threshold;
implementing a second data compression method in response to bandwidth utilization exhibited by the data processing system exceeding a respective specified threshold; and
implementing round-trip time optimization in response to said processor utilization and said bandwidth utilization being below said respective specified thresholds.

17. The method of claim 16 wherein:
implementing the first data compression method includes sending outbound data in a compressed form created using a lossy-type data compression method;
implementing the second data compression method includes compressing outbound data in a manner that provides for a corresponding compression-induced increase in response time performance; and
implementing the round-trip optimization strategy includes sending said outbound data in a compressed form in response to determining round-trip time for sending said outbound data in said compressed form is less than round-trip time for said outbound data in uncompressed form.

18. A data processing system, comprising:
at least one data processing device;
instructions processable by said at least one data processing device; and
an apparatus from which said instructions are accessible by said at least one data processing device;
wherein said instructions are configured for enabling said at least one data processing device to facilitate:
determining operating parameter levels exhibited by a data processing system, wherein at least a portion of said operating parameter levels influence response time performance for the data processing system;
determining resource optimization mode dependent upon at least one of said operating parameter levels; and
optimizing data compression influence on said response time performance dependent upon said resource optimization mode.

19. The system of claim 18 wherein determining said operating parameter levels includes at least one of monitoring processor utilization, monitoring aggregate bandwidth utilization, measuring network parameters and estimating compressibility of outbound data.

20. The system of claim 18 wherein determining said resource optimization mode includes:
selecting processor optimization in response to determining that said response time performance for the data processing unit is bound by processor utilization;
selecting bandwidth optimization in response to determining that said response time performance for the data processing system is bound by bandwidth utilization; and
selecting round-trip time optimization in response to determining that said response time performance for the data processing system is unbound by processor utilization and bandwidth utilization.

21. The system of claim 20 wherein optimizing said data compression influence includes at least one of:
in response to choosing processor optimization, comparing processor cycles required for compressing outbound data and sending said compressed outbound data and processor cycles required for sending said outbound data in uncompressed form;
in response to choosing bandwidth optimization, comparing bandwidth utilization associated with sending said outbound data in compressed form and bandwidth utilization associated with sending said outbound data in uncompressed form; and
in response to choosing round-trip time optimization, comparing round-trip time for outbound data in compressed form and round-trip time for outbound data in uncompressed form.

22. The system of claim 18 wherein optimizing said data compression influence includes at least one of:
in response to determining that response time performance for the data processing unit is bound by processor utilization, comparing processor cycles required for compressing outbound data and sending said compressed outbound data and processor cycles required for sending said outbound data in uncompressed form;
in response to determining that said response time performance for the data processing unit is bound by bandwidth utilization, comparing bandwidth utilization associated with sending said outbound data in compressed form and bandwidth utilization associated with sending said outbound data in uncompressed form; and
in response to determining that said response time performance is unbound by processor utilization and bandwidth utilization, comparing round-trip time for outbound data in compressed form and round-trip time for outbound data in uncompressed form.

23. The system of claim 18 wherein said instructions are further configured for enabling said at least one data processing device to facilitate:
compressing outbound data from the data processing systems in response to determining that said data compression provides a desired influence, wherein optimizing said data compression influence includes determining a compression factor and compressing said outbound data includes applying the compression factor to said outbound data.

24. The system of claim 23 wherein said instructions are further configured for enabling said at least one data processing device to facilitate:
updating information used in determining the compression factor in response to optimizing the influence of said data compression.

25. A data processing system, comprising:
at least one data processing device;
instructions processable by said at least one data processing device; and
an apparatus from which said instructions are accessible by said at least one data processing device;
wherein said instructions are configured for enabling said at least one data processing device to facilitate:
determining resource optimization mode for a data processing system dependent upon at least one of a plurality of operating parameter levels exhibited by the data processing system;
implementing a resource optimization strategy dependent upon at least one of said resource optimization mode, said operating parameter levels, and reference responsiveness parameters; and
updating information utilized in determining the resource optimization strategy dependent upon information derived from said implementing the resource optimization strategy.

26. The system of claim 25 wherein determining said resource optimization mode includes:
selecting processor optimization in response to determining that said response time performance for the data processing unit is bound by processor utilization;
selecting bandwidth optimization in response to determining that said response time performance for the data processing system is bound by bandwidth utilization; and
selecting round-trip time optimization in response to determining that said response time performance for the data processing system is unbound by processor utilization and bandwidth utilization.

27. The system of claim 26 wherein implementing the resource optimization strategy include optimizing data compression influence on said response time performance dependent upon said resource optimization mode.

28. The system of claim 27 wherein optimizing said data compression influence includes at least one of:
in response to determining that response time performance for the data processing unit is bound by processor utilization, comparing processor cycles required for compressing outbound data and sending said compressed outbound data and processor cycles required for sending said outbound data in uncompressed form;
in response to determining that said response time performance for the data processing unit is bound by bandwidth utilization, comparing bandwidth utilization associated with sending said outbound data in compressed form and bandwidth utilization associated with sending said outbound data in uncompressed form; and
in response to determining that said response time performance is unbound by processor utilization and bandwidth utilization, comparing round-trip time for outbound data in compressed form and round-trip time for outbound data in uncompressed form.

29. The system of claim 27 wherein implementing aid resource optimization strategy includes compressing outbound data from the data processing systems in response to optimizing said data compression in a manner that provides a desired influence, wherein optimizing said data compression influence includes determining a compression factor and compressing said outbound data includes applying the compression factor to said outbound data.

30. The system of claim 29 wherein said instructions are further configured for enabling said at least one data processing device to facilitate:
updating information used in determining the compression factor in response to optimizing the influence of said data compression.

31. The system of claim 25 wherein said instructions are further configured for enabling said at least one data processing device to facilitate:
optimizing data compression influence on said response time performance dependent upon said resource optimization mode; and
implementing the resource optimization strategy in response to optimizing said data compression in a manner that provides a desired influence, wherein said implementing includes:
implementing one of uncompressed data transmission and a first resource optimization strategy in response to processor utilization exhibited by the data processing system exceeding a respective specified threshold;
implementing a second resource optimization strategy in response to bandwidth utilization exhibited by the data processing system exceeding a respective specified threshold and
implementing a round-trip time optimization strategy in response to said processor utilization and said bandwidth utilization being below said respective specified thresholds.

32. The system of claim 31 wherein:
implementing the first resource optimization strategy includes sending outbound data in a compressed form created using a lossy-type data compression method;
implementing the second resource optimization strategy includes compressing outbound data in a manner that provides for a corresponding compression-induced increase in response time performance; and
implementing the round-trip optimization strategy includes sending said outbound data in a compressed form in response to determining round-trip time for sending said outbound data in said compressed form is less than round-trip time for said outbound data in uncompressed form.

33. A data processing system, comprising:
at least one data processing device;
instructions processable by said at least one data processing device; and
an apparatus from which said instructions are accessible by said at least one data processing device;
wherein said instructions are configured for enabling said at least one data processing device to facilitate:
determining operating parameter levels exhibited by a data processing system, wherein said operating parameter levels influence response time performance exhibited by the data processing system;
implementing one of uncompressed data transmission and a first data compression method in response to processor utilization exhibited by the data processing system exceeding a respective specified threshold;
implementing a second data compression method in response to bandwidth utilization exhibited by the data processing system exceeding a respective specified threshold; and
implementing a round-trip time optimization strategy in response to said processor utilization and said bandwidth utilization being below said respective specified thresholds.

34. The system of claim 33 wherein:
implementing the first data compression method includes sending outbound data in a compressed form created using a lossy-type data compression method;
implementing the second data compression method includes compressing outbound data in a manner that provides for a corresponding compression-induced increase in response time performance; and
implementing the round-trip optimization strategy includes sending said outbound data in a compressed form in response to determining round-trip time for sending said outbound data in said compressed form is less than round-trip time for said outbound data in uncompressed form.
